(19) United States
(12) Patent Application Publication
(10) Pub. No.: US 2024/0278247 A1
(43) Pub. Date: Aug. 22, 2024

(54) ADAPTER FOR CLINICAL, MEDICAL AND LABORATORY CONTAINERS

(71) Applicant: Vertice Pharma LLC, Berkeley Heights, NJ (US)

(72) Inventors: Sunil Vandse, Basking Ridge, NJ (US); Vinayagam Kannan, Morris Plains, NJ (US); Jake P. Ganem, Cape Neddick, ME (US)

(73) Assignee: Vertice Pharma LLC, Berkeley Heights, NJ (US)

(21) Appl. No.: 18/570,437

(22) PCT Filed: Jun. 20, 2022
(86) PCT No.: PCT/US22/34137

§ 371 Date: Dec. 14, 2023

Related U.S. Application Data
(60) Provisional application No. 63/213,076, filed on Jun. 21, 2021.

(51) Int. Cl. B01L 3/00

(52) U.S. Cl. CPC B01L 3/563; B01L 2200/0615; B01L 2300/0832

(57) ABSTRACT

An adapter for clinical, medical and laboratory equipment containers comprises: (a) a cylindrical substrate wherein the substrate comprises a plurality of ribs that extend outwardly from the substrate to orient and hold the adapter in an opening of the container and (b) an elastomeric insert that is formed or inserted into an opening in the substrate wherein the elastomeric insert comprises: (i) a transfer instrument passageway that allows a tip of a transfer implement to pass through the elastomeric insert and allow a liquid contained in the container to be drawn into the transfer implement and (ii) an air passage structure to allow air to be drawn into the container when the liquid is being drawn into the transfer implement.

### FIELD OF THE INVENTION

The present invention relates to an adapter for use with clinical, medical and laboratory equipment and supplies. More particularly relates to adapters for use on bottles, vials and other containers adapted to admit passage of liquid transfer implements such as pipettes and tips of syringes into the container for drawing liquids held therein, including oral liquid medications and dose forms. In certain embodiments the adapter is of particular use for bottles containing oral liquid dosage forms that contain levothyroxine or liothyronine.

### BACKGROUND OF THE INVENTION

Many adapters have been conceived for the afore described purpose. Known closures include those which are initially closed and are torn open by force of an implement tip as well as those which are pre-cut with slits of various configurations to facilitate passage and entry of the transfer implement tip. A common difficulty with prior art closures has been that the closure encompasses and grips the transfer implement to form an air tight seal which prevents air pressure within the container from equilibrating with ambient air pressure. As liquid is drawn from the container a vacuum is created which limits the liquid flow into the transfer implement, and may pull fluid out of the transfer implement as the transfer implement is withdrawn from the container. In prior closures various measures have been taken to provide air passages and vents, through the closure to facilitate equilibration of internal and ambient air pressures. Some examples of the prior closure devices are described in U.S. Pat. Nos. 6,951,295; 9,296,531; 10,058,481; 10,266,316 and 10,315,814 the contents of which are incorporated herein by reference.

The prior art closure devices may leak when the container is inverted during storage, transport or in use with the transfer implement.

The prior art closure devices may also result in an inaccurate dose or amount of the liquid contained within in the container being transferred to the transfer implement, such as a syringe due to the pressure differential. This is especially problematic when the therapeutic doses to be withdrawn contain microgram amounts of drug such as levothyroxine or liothyronine.

The prior art closure devices may also interact with the liquid contained within the container causing unwanted and potentially dangerous leaching of the impurities from the closure device into the liquid contained within the container or degradation of the ingredients comprising the liquid contained within the container, particularly a drug such as levothyroxine or liothyronine.

Therefore, an objective of this invention is to provide an adapter for clinical, medical and laboratory equipment and supplies and particularly for use on bottles, vials and other containers adapted to admit passage of liquid transfer implements such as the tips of pipettes and oral syringes into the container for drawing one or more samples or doses of the liquids held within the container into the transfer implement. The adapter prevents the leakage of the liquid held within the container during storage, during transport and/or during use (withdrawing a sample or dose of the liquid). The adapter also allows for a single and repeated accurate and consistent removal of samples or doses of the liquid contained within the container. The adapter further resists leaching of contaminants into the liquid contained within the container and limits or prevents degradation of the ingredients comprising the liquid contained with the container. These and other objectives are obtained by the present invention described herein.

### SUMMARY OF THE INVENTION

This present invention is an adapter that provides a self-venting, self resealing pre-cut elastomeric closure for containers such as vials and bottles from which samples or doses of a liquid held within the container are drawn with transfer implements such as pipettes, oral syringes, and Luer syringes such as Luer slip taper syringes.

Embodiments of the present invention are useful for accurately and easily withdrawing a single or multiple dose of an oral liquid medication from a vial or bottle with an oral syringe or Luer syringe such as Luer slip taper syringe to allow for accurate dosing of the liquid medication to a patient. The withdrawing of the dose may be a single withdraw or may be repeated withdrawals over a single day, multiple days, weeks or months.

Embodiments of the present invention are particularly useful for accurately and easily withdrawing doses of oral liquid levothyroxine or liothyronine compositions from a vial or bottle with an oral syringe or Luer syringe such as Luer slip taper syringe to allow for accurate dosing of the oral liquid levothyroxine or liothyronine compositions. The oral liquid levothyroxine or liothyronine compositions that may be used include those described in U.S. Pat. No. 9,050,307, U.S. Patent Application Publication Nos. 2019/0321316 and 2020/0276112, U.S. Provisional Patent Application Ser. No. 63/175,190 filed on Apr. 15, 2021 and International Patent Application No. PCT/US2022/24729 filed Apr. 14, 2022 which are incorporated herein by reference.

Embodiments of the present invention are also particularly useful for accurately and easily withdrawing doses of oral liquid gliptin compositions such as sitagliptin from a vial or bottle with an oral syringe or Luer syringe such as Luer slip taper syringe to allow for accurate dosing of the oral liquid gliptin compositions. The oral liquid gliptin compositions that may be used include those described in International Patent Application Publication Nos. WO 2021/078964 and WO 2015/044880 and European Patent Application Publication Nos. 1354882 and 1828192 which are incorporated herein by reference.

In certain embodiments the container for the liquid and into which the adapter of the present invention is inserted may be a pharmaceutically acceptable container such as a glass bottle, or vial or a plastic bottle or vial. Representative containers are described in U.S. Pat. Nos. 9,050,307; 10,537,538 and 6,706,255, which are incorporated herein by reference. In certain embodiments, the container is an amber glass or amber PET bottle.

In certain embodiments the adapter is made by injection molding, preferably a two shot injection molding process wherein an adapter substrate is molded in the first shot and an elastomeric insert is molded in the second shot. In certain aspects of this embodiment, the elastomeric insert comprises a passage for withdrawing the liquid held within the container into a transfer implement such as a pipette, oral syringe or Luer syringe such as Luer slip taper syringe. In certain aspects of this embodiment, the elastomeric insert comprises a passage for allowing air to enter into the container when the liquid held within the contained is being withdrawn into a transfer implement.

### BRIEF DESCRIPTION OF THE DRAWINGS

FIG. 1 is a top-side perspective view of an embodiment of a substrate of an adapter of the present invention without an elastomeric insert.

FIG. 2 is a side view of the substrate of the adapter of the present invention shown in FIG. 1.

FIG. 3 is a top view of the substrate of the adapter of the present invention without the elastomeric insert shown in FIG. 1.

FIG. 4 is a cross sectional view of the substrate of the adapter of the present invention without the elastomeric insert taken along line A-A of FIG. 3.

FIG. 5 is a top-side perspective view of an embodiment of an adapter of the present invention with an embodiment of an elastomeric insert.

FIG. 6 is a top view of the adapter of the present invention with the elastomeric insert shown in FIG. 5.

FIG. 7 is an expanded view of section C of FIG. 6.

FIG. 8 is a cross sectional view of the adapter of the present invention with the elastomeric insert taken along line A-A of FIG. 6.

FIG. 9 is an expanded view of section D of FIG. 8.

FIG. 10 is a bottom-side perspective view of an embodiment of an elastomeric insert of the present invention.

FIG. 11 is a top-side perspective view of an embodiment of the elastomeric insert of the present invention shown in FIG. 10.

FIG. 12 is a top-side perspective view a bottle with an embodiment of the adapter of the present invention.

FIG. 13 is an expanded top-side perspective view of the bottle and adapter of FIG. 10.

FIG. 14 is a cross sectional view of the bottle and adapter taken along line A-A of FIG. 13.

FIG. 15 is a cross sectional view of the bottle and adapter taken along line B-B of FIG. 13.

### DETAILED DESCRIPTION

Before the present invention is further described, it is to be understood that this invention is not limited to the particular embodiments described. It is also to be understood that the terminology used herein is for the purpose of describing particular embodiments only, and is not intended to be limiting.

It should be noted that as used herein, the singular forms “a,” “an,” and “the” include plural referents unless the context clearly dictates otherwise.

The present invention provides an adapter for clinical, medical and laboratory containers, preferably bottles or vials, wherein the adapter comprises a self-venting and self-resealing elastomeric insert. The elastomeric insert will permit withdrawing or removing a sample or dose of a liquid contained within the bottle or vial with a transfer implement such as a pipette, oral syringe or Luer syringe such as Luer slip taper syringe. In certain embodiments the liquid within the bottle or vial is a liquid medication or liquid dosage form that may be orally administered to a subject or patient in need of the medicine. In certain embodiments the transfer implement is a conventional oral syringe or Luer syringe comprising a plunger, barrel and tip wherein the liquid is withdrawn from the bottle or vial by inserting the tip of the syringe through a preformed passageway in an elastomeric insert of the adapter, inverting the bottle or vial to allow the liquid within the bottle or vial to contact the adapter and the tip of the oral syringe or Luer syringe and drawing the liquid from within the bottle or vial into the barrel of the syringe by moving the plunger of the syringe away from the tip of the syringe. As the liquid is drawn into the syringe, air is allowed to enter the bottle or vial via a preformed vent in the adapter, preferably in the elastomeric insert, and thereby prevent the formation of a pressure gradient or vacuum in the bottle or vial and syringe. Once the appropriate amount of liquid is withdrawn from the bottle or vial and into the syringe, the tip of the syringe is withdrawn from the adapter allowing both the transfer implement passageway in the elastomeric insert and the air vent passageway to close or seal.

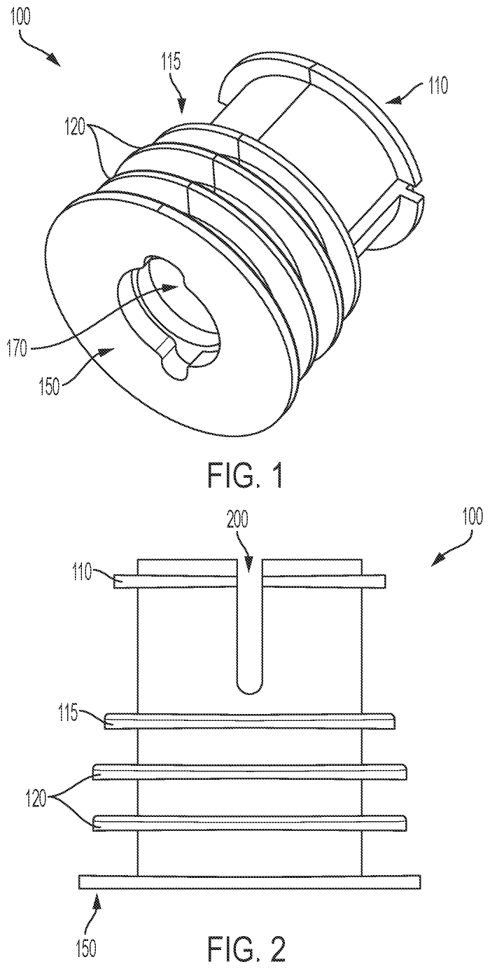

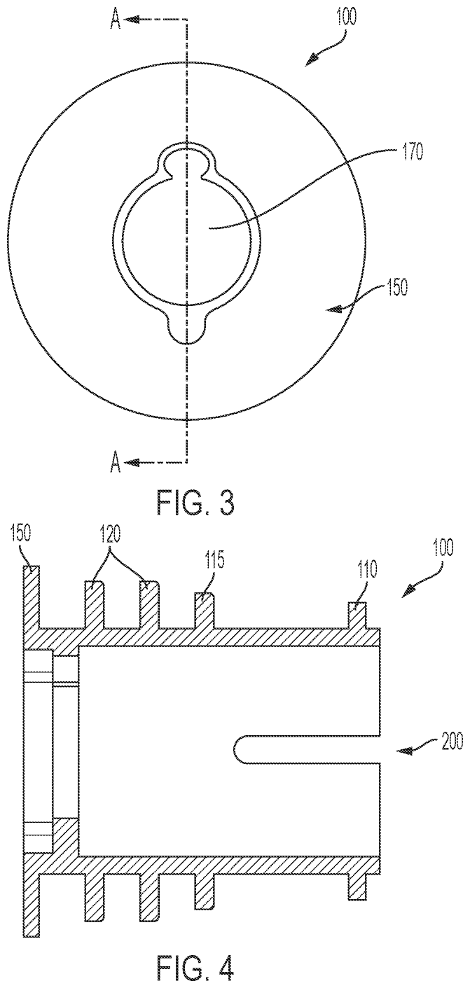

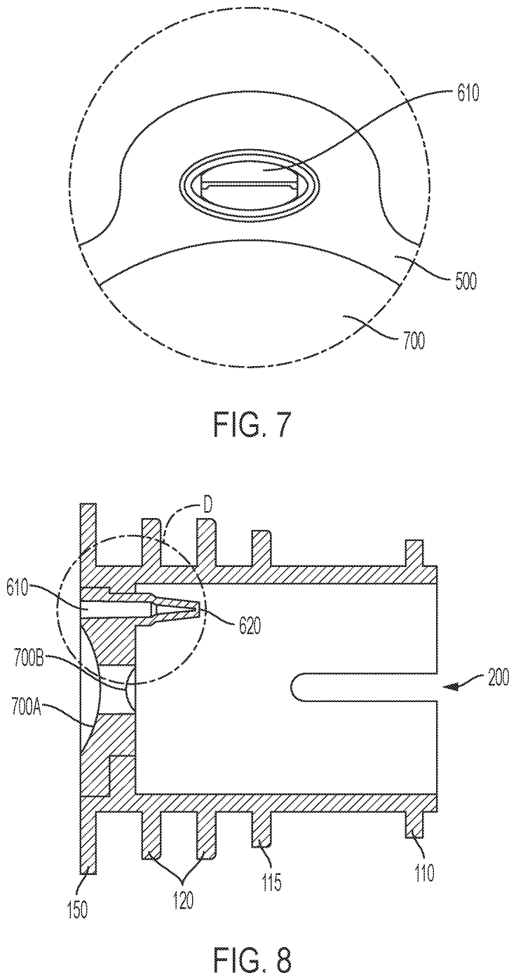

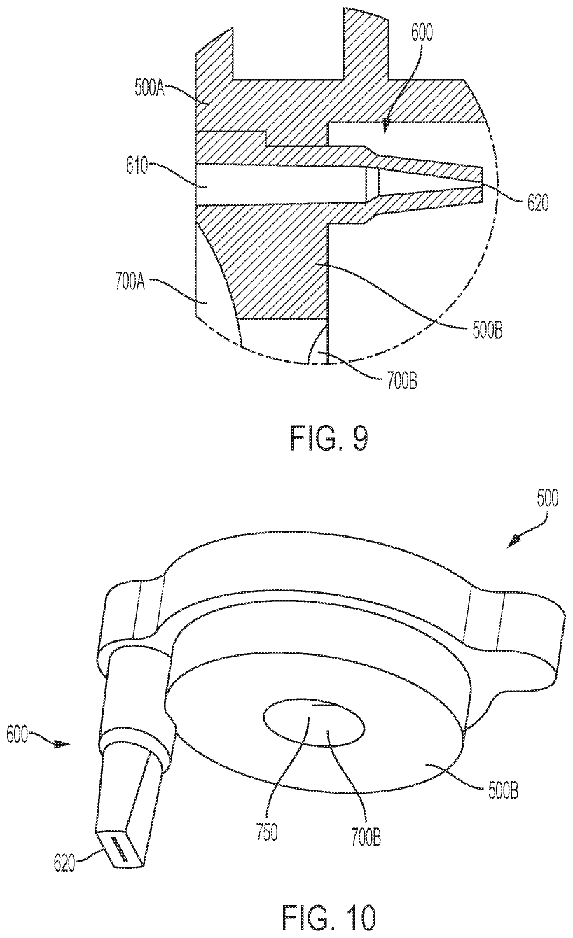

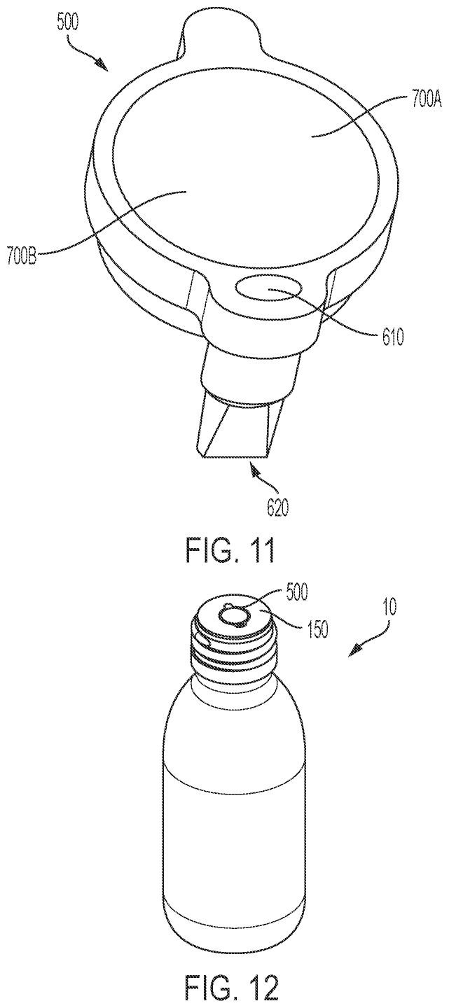

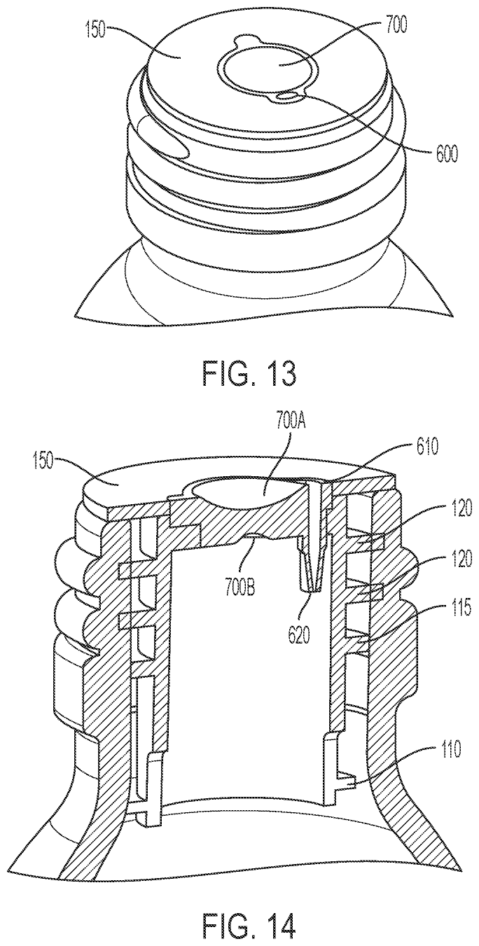

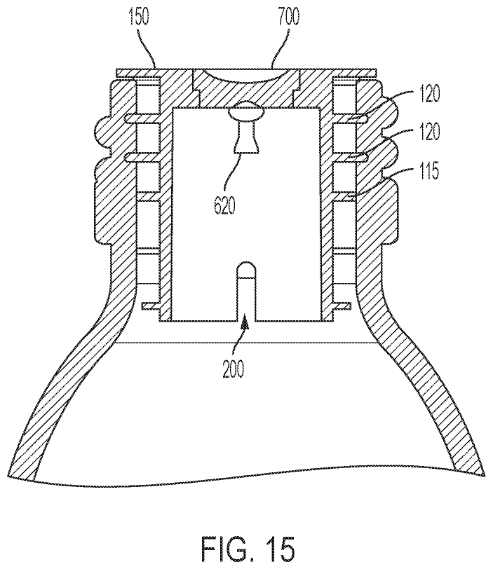

One embodiment of the adapter of the present invention is shown in FIGS. 1-15. As shown in FIG. 1, the adapter comprise a cylindrical substrate 100 adapted to fit tightly when pressed into the mouth or opening of a container such as a bottle 10 shown in FIGS. 10-13. The cylindrical substrate 100 has a plurality of ribs, 110, 115 and 120 that extend outwardly from the barrel of the cylindrical substrate 100 and engage the inner surface 10B of the neck of the bottle 10. As shown in FIGS. 2 and 3, ribs 110, 115 and 120 have increasing diameters. Specifically the diameter of the first rib 110, which is positioned near the base or part of the substrate 100 that first is inserted into the opening of bottle 10 is smaller than the diameter of the second rib 115 and the diameter of the second rib 115 is smaller than the diameter of the third rib 120. This increasing diameter allows for the adapter to be easily inserted into the opening of the bottle 10.

The diameter of the first rib 110 should be slightly smaller than the inner diameter of the opening of bottle 10. The first rib 110 may act as a guide for centering/orienting the adapter into the opening of the bottle 10. The diameter of the first rib 110 should be about 95% to about 99.9% of the inner diameter of the opening of the bottle 10.

The diameter of the second rib 115 should be approximately the same diameter as the inner diameter of the opening of the bottle 10 or a diameter about 0.5% to about 5% greater than the inner diameter of the opening of the bottle 10. The second rib 115 may provide a leak proof seal that prevents the liquid contained within the bottle 10 from escaping the bottle 10 when the bottle 10 is inverted.

The diameter of the third rib 120 should be approximately about 0.75% to about 10% greater than the inner diameter of the opening the bottle 10. In certain embodiments more than one third rib may be present. The third rib 120 should provide a leak proof seal that prevents the liquid contained within the bottle 10 from escaping the bottle 10 when the bottle 10 is inverted. The third rib 120 should also secure the adapter in the opening of the bottle 10 and prevent the removal of the adapter once it is inserted into the opening.

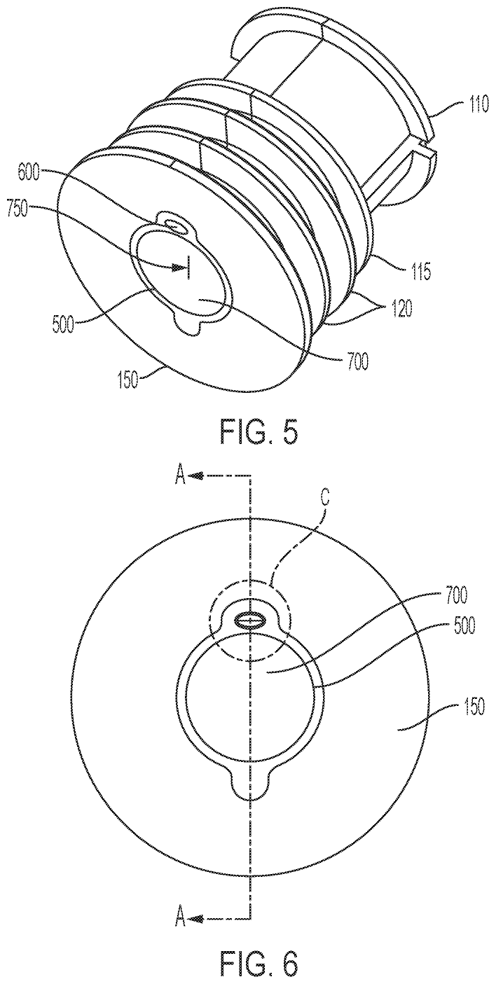

As shown in FIGS. 2 and 4, the substrate 100 also comprises a slot or return passageway 200 that extends from the base of the substrate to an area below the second rib 115. The return passageway 200 allows any liquid that is contained within the bottle 10 and that passes over the first rib 110 when the bottle 10 with the adapter in place is inverted to return to the interior of the bottle 10 when the bottle is returned to its normal upright orientation.

The substrate 100 of the adapter will further comprise a top or cover 150. The top 150 should have a diameter that is larger than the inner diameter of the opening of bottle 10. The size of top 150 will act as a stop and prevent the adapter from being inserted too far into the opening of the bottle 10. In certain embodiments the diameter of the top 150 should be equal to and slightly smaller than the outer diameter of the opening of bottle 10 but larger than the inner diameter of the opening of bottle 10.

The top 150 of the substrate 100 will also comprise at least one opening 170 which will receive an elastomeric insert 500. The elastomeric insert 500 may be a single insert comprising both a transfer instrument interface 700 and an air passage structure 600.

The elastomeric insert 500 comprises at least a transfer instrument interface 700 and an air passage structure 600. The transfer instrument interface 700 comprises a transfer instrument passageway 750 that extend through the elastomeric insert 500 and thereby allows the passage of the transfer instrument, i.e. the tip of the pipette or syringe to pass through the elastomeric insert 500 and engage the liquid contained within the bottle 10. The transfer instrument interface 700 may be any shape but in certain embodiments the transfer instrument interface 700 may be circular as shown in FIGS. 5 and 6. The transfer instrument passageway 750 may a single linear cut that extends through the elastomeric insert 500 and is contained within the transfer instrument interface 700. The transfer instrument passageway 750 may also comprise a plurality of cuts wherein the plurality of cuts intersect, preferably in the center of the transfer instrument interface 700 forming a cross or star pattern or alternatively form a Z or N shaped pattern. In certain embodiments the transfer instrument passageway 750 is formed during the injection molding of the elastomeric insert 500 or after the molding of the elastomeric insert 500.

In certain embodiments the transfer instrument interface 700 comprises an exterior surface 700A that is concave and an interior surface 700B is also concave. The concave exterior surface 700A allows the user to guide the tip of the transfer instrument, i.e. pipette or syringe, into the transfer instrument passageway 750 and easily insert the tip through the transfer instrument passageway 750. The concave interior surface 700B helps prevent the deformation of the elastomeric insert when the tip of the transfer instrument is inserted through the transfer instrument passageway 750 and thereby avoid potential sealing of the air passage structure 600 due to the deformation of the elastomeric insert 500. The thickness of the instrument transfer interface 700 should be sufficient to allow the tip of the transfer instrument, i.e. pipette or syringe, to extend through the elastomeric insert 500 and into the interior cavity of the bottle 10. The thickness and elasticity of the instrument transfer interface 700 should be sufficient to maintain the tight leak proof seal when the bottle is inverted and the liquid contained within the bottle 10 is transferred (withdrawn) into the transfer instrument as well as forming a tight leak proof seal after the transfer instrument is withdrawn from the adapter.

As shown in FIGS. 6-11, the air passage structure 600 may also be formed in the elastomeric insert 500. The purpose of the air passage structure 600 is to allow the entry of air into the interior of the bottle 10 when the liquid content of the bottle 10 is being withdrawn or transferred into a transfer instrument, i.e. pipette or syringe, and thereby prevent the creation of a pressure gradient or vacuum within the bottle 10 and the transfer instrument. In certain embodiments the air passage structure 600 comprises a channel or passageway 610 the extends from the exterior or top surface of the elastomeric insert 500A through the elastomeric insert and forms a resilient and deformable valve 620 on the interior surface of the elastomeric insert 500B. The value 620 will extend from the interior surface of the elastomeric insert 500 but will not extended beyond the length of the cylindrical substrate 100, preferably not beyond the second rib 115 of the cylindrical substrate 100 or the third rib 120 of the cylindrical substrate 100. In certain embodiments the valve 620 may have a conical shape or an opposing flap, i.e., duck bill shape. The dimensions and elasticity of the valve 620 should be sufficient to prevent the leakage of the liquid contained within the bottle 10 when the bottle is inverted and the liquid within the bottle is in contact with the adapter for at least one hour or longer. The dimensions and elasticity of the value 620 should also be sufficient to allow the flaps to separate and permit air to be drawn into the interior of the bottle 10 as the liquid within the bottle 10 is being withdrawn into the transfer instrument thereby avoiding the creation of a vacuum within the bottle during the transfer of the liquid. The dimensions and elasticity of valve 620 should also allow a quick return to a tight leak proof seal position or orientation as soon the transfer of the liquid into the transfer instrument is completed.

In certain embodiments the air passage structure 600 comprising the channel 610 and valve 620 are formed or molded into the elastomeric insert 500 along with the transfer instrument interface 700 comprising the transfer instrument passageway 750. In certain aspects of this embodiment the elastomeric insert 500 comprising the air passage structure 600 and transfer interface 700 is molded into the adapter substrate 100 in a single step and the passageway in the valve 620 and transfer instrument passageway 750 are formed by cutting or piercing the formed elastomeric insert 500.

The adapter substrate 100 may be formed from any pharmaceutically acceptable polymeric material including but not limited to polyethylene, polypropylene, low density polypropylene or high density polypropylene. The elastomeric insert 500 may be formed from silicone, rubber or elastomeric thermosets which may include but are not limited to thermoplastic elastomers such as those commercially available under the tradename DYNAFLEX® G2706, DYNAFLEX® G2711; MEDALIST® MD12130, MEDALIST® MD12140, MEDALIST® MD12150, MEDALIST® MD12160, MEDALIST® MD12170 and MEDALIST® MD12180. Other examples of the pharmaceutically acceptable materials for the elastomeric insert 500 can be found in in U.S. Pat. Nos. 6,951,295; 9,296,531; 10,058,481; 10,266,316 and 10,315,814 the contents of which are incorporated herein by reference

The adapter of the present invention should not leach any contaminants or impurities into the liquid contained with the bottle 10 when the adapter is inserted into the bottle and the bottle is sealed with a closure such as a child resistant screw cap and stored in an inverted positon for at least 1, 2, 3, 4, 5, 6, 7, 8, 9, 10 weeks or longer. The adapter of the present invention should also not cause any degradation or accelerate the formation impurities in the liquid contained with the bottle 10 when the adapter is inserted into the bottle and the bottle is sealed with a closure such as a child resistant screw cap and stored in an inverted positon for at least 1, 2, 3, 4, 5, 6, 7, 8, 9, 10 weeks or longer. More specifically, the liquid contained within the bottle will contain about 1.0% or less of any individual degradation or impurity product, preferably about 0.75% or less of any individual degradation or impurity product, and most preferably about 0.5% or less of any individual degradation or impurity product when the adapter is inserted into the bottle and the bottle is sealed with a closure such as a child resistant screw cap and stored in an inverted positon for at least 1, 2, 3, 4, 5, 6, 7, 8, 9, 10 weeks or longer, at approximately 25° C. and approximately 60% relative humidity and/or at approximately 40° C. and approximately 75% relative humidity. The liquid contained within the bottle will contain about 2.0% or less of total degradation and impurity products, preferably about 1.5% or less of total degradation and impurity products, and most preferably about 1.0% or less of total degradation and impurity products when the adapter is inserted into the bottle and the bottle is sealed with a closure such as a child resistant screw cap and stored in an inverted positon for at least 1, 2, 3, 4, 5, 6, 7, 8, 9, 10 weeks or longer, at approximately 25° C. and approximately 60% relative humidity and/or at approximately 40° C. and approximately 75% relative humidity.

The present invention also includes a kit comprising: (i) a bottle or vial comprising multiple doses of a liquid medication that is sealed with a closure such as a pharmaceutically acceptable child-resistant cap; (ii) an adapter as described herein and (iii) a transfer instrument, preferably an oral syringe or Luer syringe with calibrated markings indicating appropriate single dose amounts or volumes. The kit may further comprise instructions for inserting the adapter into the bottle and withdrawing the appropriate or prescribed single dose of the liquid medication into the transfer instrument for administration to the patient. In certain embodiments, the (i) bottle or vial, (ii) the adapter and (iii) the transfer instrument are packaged separately in the kit and provided to the pharmacist or care provider with instructions for inserting the adapter into the bottle and dispensing single doses of the liquid medication. In certain embodiments, once the adapter is inserted into the bottle and a single dose of the liquid medication is withdrawn, the child resistant cap may be replaced on the bottle with the adapter in place and safely stored until the next single dose of the liquid medication needs to be removed from the bottle and administered to the patient.

The invention described herein may be practiced in the absence of any element or elements, limitation or limitations which is not specifically disclosed herein. Thus, for example, in each instance herein, any of the terms “comprising,” “consisting essentially of,” and “consisting of” may be replaced with either of the other two terms. The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the claims.

1. An adapter for clinical, medical and laboratory equipment containers comprising:
(a) a cylindrical substrate wherein the substrate comprises a plurality of ribs that extend outwardly from the substrate to orient and hold the adapter in an opening of the container and
(b) an elastomeric insert that is formed or inserted into an opening in the substrate wherein the elastomeric insert comprises: (i) a transfer instrument passageway that allows a tip of a transfer implement to pass through the elastomeric insert and allow a liquid contained in the container to be drawn into the transfer implement and (ii) an air passage structure to allow air to be drawn into the container when the liquid is being drawn into the transfer implement.

2. The adapter of claim 1 wherein the diameter of a first rib which is positioned near the base of the cylindrical substrate that is inserted into the opening of the container has a diameter that is smaller than a diameter of the remaining ribs that extend outwardly from the cylindrical substrate.

3. The adapter of claim 2 wherein the diameter of the first rib is about 95% to about 99.9% of the inner diameter of the opening of the container.

4. The adapter of claim 2 wherein the plurality of ribs comprises at least a second rib and a third rib wherein the diameter of the second rib is about 0.5% to about 5% greater than the inner diameter of the opening of the container, the diameter of third rib is about 0.75% to about 10% greater than the inner diameter of the opening the container and the second rib is located between the first rib and third rib and the third rib is located further from the base of the cylindrical substrate than the first and second ribs.

5. The adapter of claim 4 wherein the cylindrical substrate further comprises a return passageway that extends from the base of the cylindrical substrate to an area below the second rib to allow any liquid that is contained within the container and that passes over the first rib when the container with the adapter in place is inverted to return to the interior of the container when the container is returned from an inverted orientation to a normal upright orientation.

6. The adapter of claim 2 wherein the cylindrical substrate further comprise a top cover portion opposite the base wherein the top cover portion has a diameter that is larger than the inner diameter of the opening of container.

7. The adapter of claim 1 wherein the transfer instrument passageway is a single linear cut that extends through the elastomeric insert.

8. The adapter of claim 1 wherein the transfer instrument passageway comprises a plurality of cuts that extend through the elastomeric insert wherein the plurality of cuts intersect forming a cross pattern, a star pattern, a Z shaped pattern or an N shaped pattern.

9. The adapter of claim 1 wherein the transfer instrument passageway is located in a concave exterior area of the elastomeric insert and the concave exterior area allows a user to guide a tip of a transfer instrument selected from the group of a pipette or syringe, into the transfer instrument passageway.

10. The adapter of claim 9 wherein the elastomeric insert further comprises a concave interior area that is opposite the concave exterior area.

11. The adapter of claim 1 wherein the air passage structure comprises a passageway that extends from the surface of the elastomeric insert that is outside the container when the adapter is inserted into the container opening, through the elastomeric insert and forms a resilient and deformable valve on the surface of the elastomeric insert that is inside the container when the adapter is inserted into the container and the formed value extends from the inside surface of the elastomeric insert but does not extended beyond the length of the cylindrical substrate.

12. The adapter of claim 11 wherein the valve is formed in a conical shape or duck bill shape.

13. An adapter for a bottle or vial comprising multiple doses of a liquid medication wherein the adapter comprises:
(a) a cylindrical substrate with a base region for inserting the adapter into an opening of the bottle or vial and a top region that is opposite the base region and the cylindrical substrate further comprises (i) at least three ribs that extend outwardly from the cylindrical substrate to engage an inner surface of the opening of the bottle or vial wherein the first rib has a diameter that is about 95% to about 99.9% of the inner diameter of the bottle or vial opening; the second rib has a diameter that is about 0.5% to about 5% greater than the inner diameter of the bottle or vial opening, the third rib has a diameter that is about 0.75% to about 10% greater than the inner diameter of the bottle or vial opening and the second rib is located between the first rib and third rib and the third rib is located further from the base region of the cylindrical substrate than the first and second ribs and (ii) a return passageway that extends from the base region of the cylindrical substrate to an area below the second rib to allow any liquid that is contained within the bottle or vial and that passes over the first rib when the bottle or vial with the adapter inserted into the bottle or vial opening is inverted to return to the interior of the bottle or vial when the bottle or vial is returned from an inverted orientation to a normal upright orientation
(b) an elastomeric insert comprising (i) a concave exterior region and a concave interior region that is opposite the concave exterior region wherein the concave regions further comprise a transfer instrument passageway that allows a tip of an oral syringe or Luer syringe to pass through the elastomeric insert and contact the liquid contained in the bottle or vial and be drawn into the oral syringe or Luer syringe and (ii) an air passage structure to allow air to be drawn into the bottle or vial when the liquid in the bottle or vial is being drawn into the oral syringe or Luer syringe wherein the air passage structure comprises a passageway that extends from the surface of the elastomeric insert that is outside the bottle or vial when the adapter is inserted into the bottle or vial opening, the through the elastomeric insert and forms a resilient and a deformable conical shaped or duck bill shaped valve on the surface of the elastomeric insert that is inside the bottle or vial when the adapter is inserted into the bottle or vial opening and the value extends from the inside surface of the elastomeric insert but does not extended beyond the length of the cylindrical substrate.

14. The adapter of claim 13 wherein the liquid medication is an oral liquid medication.

15. The adapter of claim 14 wherein the oral liquid medication comprises levothyroxine or liothyronine.

16. The adapter of claim 14 wherein the oral liquid medication comprises a gliptin.

17. The adapter of claim 16 wherein the oral liquid medication comprises a sitagliptin.

18. A kit comprising: (i) a bottle or vial comprising multiple doses of an oral liquid medication that is sealed with a child resistant cap; (ii) an adapter as described in claim 13; (iii) an oral syringe or Luer syringe with calibrated markings indicating appropriate single dose amounts or volumes and (iv) instructions for inserting the adapter into the bottle or vial and/or withdrawing an appropriate single dose of the liquid medication into the oral syringe or Luer syringe for administration to a patient after the adapter has been inserted into the bottle or vial.

19. The kit of claim 18 wherein the child resistant cap is replaced on the bottle or vial with the adapter in place to allow the bottle or vial comprising the multiple doses of liquid medication to be stored until the next single dose of the liquid medication needs to be removed from the bottle or vial and administered to the patient.
